(19) United States
(12) Patent Application Publication
(10) Pub. No.: US 2013/0151822 A1
(43) Pub. Date: Jun. 13, 2013

(54) Efficient Enqueuing of Values in SIMD Engines with Permute Unit

(71) Applicants: Alexandre E. Eichenberger, Chappaqua, NY (US); John K.P. O'Brien, South Salem, NY (US); Yuan Zhao, Sugar Land, TX (US)

(72) Inventors: Alexandre E. Eichenberger, Chappaqua, NY (US); John K.P. O'Brien, South Salem, NY (US); Yuan Zhao, Sugar Land, TX (US)

(73) Assignee: INTERNATIONAL BUSINESS MACHINES CORPORATION, Armonk, NY (US)

(21) Appl. No.: 13/315,596

(22) Filed: Dec. 9, 2011

(51) Int. Cl. G06F 9/38

(52) U.S. Cl. 712/234; 712/E09.045

(57) ABSTRACT

Mechanisms, in a data processing system having a processor, for generating enqueued data for performing computations of a conditional branch of code are provided. Mask generation logic of the processor operates to generate a mask representing a subset of iterations of a loop of the code that results in a condition of the conditional branch being satisfied. The mask is used to select data elements from an input data element vector register corresponding to the subset of iterations of the loop of the code that result in the condition of the conditional branch being satisfied. Furthermore, the selected data elements are used to perform computations of the conditional branch of code. Iterations of the loop of the code that do not result in the condition of the conditional branch being satisfied are not used as a basis for performing computations of the conditional branch of code.

### BACKGROUND

The present application relates generally to an improved data processing apparatus and method and more specifically to mechanisms for efficient enqueuing of values in single-instruction-multiple-data (SIMD) engines that employ a permute unit.

Conditional branches within code loops are a common programming construct used in modem computer programs. FIG. 1A is an example of one type of scalar code loop in which a conditional branch is provided. As shown in FIG. 1A, for values i=0 to 63, the value a[i] is calculated and is used as a basis for evaluating the condition of the “if” branch within the code loop. If it is assumed that the condition of the “if” branch is true approximately 50% of the time, it follows that half of the iterations of the “for” loop will require the results of the “then” portion of the “if” branch to be calculated. That is, for approximately half of the values of i from 0 to 63, the value for t would need to be calculated and for the other half of the values of i, the value oft is not utilized.

The code shown in FIG. 1A is scalar code, i.e. code that is not optimized for parallel computations. In modern processor architectures, parallel processing functionality is provided, such as in vector processing architectures, e.g., a single-instruction-multiple-data (SIMD) engine, so that an increase in performance is obtained by executing instructions on a plurality of data in a parallel fashion. For example, with a vectorized architecture or SIMD engine, a vector register of data elements is provided with a single instruction being executed in parallel on all of the data elements of the vector register. However, in order to support such functionality, scalar code must be converted and optimized, such as by a compiler or the like, for execution in a vectorized or SIMD environment. Such converted or optimized code will be referred to herein as vectorized or SIMDized code.

FIG. 1B is an example of a SIMDized code corresponding to the loop code shown in FIG. 1A. As shown in FIG. 1A, the code includes a “for” loop for values i from 0 to 63. Different from the code in FIG. 1A, however, is that the iterations of the “for” loop are by 4 since the vector registers in the depicted example are able to store 4 data elements and thus, the instructions in the SIMDized code operate on 4 data elements in parallel. With each iteration of the “for” loop, the four values for a[i+0 . . . 3] are calculated.

Based on the values of a[i+0 . . . 3], predicate values pred[0 . . . 3] are computed to determine if the condition of the “if” loop in FIG. 1A is true or false. That is, the “if” branch in FIG. 1 A is replaced with the predicate computation in FIG. 1B which results in a vector register that stores values of either “true” or “false” for each of the four data elements i+0 to i+3. These predicate values may he, for example, a 1 value if the condition is evaluated to be true and a 0 value if the condition is evaluated to be false.

Continuing on with the code in FIG. 1B, the t value for all of the four values in the a[i+0 . . . 3] vector register is calculated and stored in a t vector register. That is, the “then” clause of the “if” branch in FIG. 1A is computed for all iterations and all data elements of each iteration of the “for” loop regardless of whether the “if” branch is taken or not. The t′[0 . . . 3] is then generated by performing a selection of t values based on the predicate values in the predicate vector register pred[0 . . . 3]. That is, the t′[0 . . . 3] vector register stores either the corresponding value in the t[0 . . . 3] vector register if the corresponding predicate vector register value is true (i.e. for that data element the “if” branch is taken), or a 0 value if the predicate vector register value is false.

It can be seen from the above that because the value oft is computed regardless of whether the “if” branch is taken or not in the SIMDized code, there is wasted computation when the “if” branch is not taken and thus, the t value did not need to be computed. If it is assumed that the “if” branch is taken only 50% of the time, then 50% of the computations oft are discarded and result in wasted computations, i.e. wasted processor cycles and wasted resources for storing the t values and performing the selection of t values using the vector register t′[0 . . . 3].

### SUMMARY

In one illustrative embodiment, a method, in a data processing system having a processor, for generating enqueued data for performing computations of a conditional branch of code. The method comprises generating, by mask generation logic of the processor, a mask representing a subset of iterations of a loop of the code that results in a condition of the conditional branch being satisfied. Moreover, the method comprises using the mask to select data elements from an input data element vector register corresponding to the subset of iterations of the loop of the code that result in the condition of the conditional branch being satisfied. Furthermore, the method comprises using the selected data elements to perform computations of the conditional branch of code. Iterations of the loop of the code that do not result in the condition of the conditional branch being satisfied are not used as a basis for performing computations of the conditional branch of code.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram of scalar code in which a conditional branch is provided within a loop;

FIG. 1B is an example diagram of a vectorized or SIMDized version of the scalar code provided in FIG. 1A;

FIG. 2 is an exemplary block diagram of a data processing system in which exemplary aspects of the illustrative embodiments may be implemented;

FIG. 3 is a block diagram of a processor architecture having a permute unit in accordance with one illustrative embodiment;

FIG. 4 is an exemplary diagram of a modified form of the processor architecture shown in FIG. 3 in which exemplary aspects of the illustrative embodiments may be implemented;

FIG. 5 is an exemplary diagram illustrating a legacy scalar ISA that is overlaid on the floating point only vector SIMD ISA of the illustrative embodiments such that legacy instructions may be executed using the vector registers of the illustrative embodiments;

FIG. 6 is an exemplary diagram illustrating how the same vector registers may be used to perform legacy scalar computation operations as well as vector computation operations;

FIG. 7 is an exemplary diagram of the permutation logic for a quad-processing unit in accordance with one illustrative embodiment;

FIG. 8 is an example diagram of code, corresponding to the code in FIG. 1B, which has been rewritten to identify “true” predicate values;

FIG. 9 is an example block diagram illustrating the primary operational elements in accordance with one illustrative embodiment;

FIG. 10 illustrates the Enqueue and CountPredOn instructions as well as the preferred use of these instructions with the permute and store instructions for an unaligned memory access processor architecture;

FIG. 11 illustrates an example operation of the preferred implementation of the Enqueue instruction and countPredOn instructions in the manner shown in FIG. 10;

FIG. 12 is an example diagram illustrating a enqueuing instruction for generating a left alignment pattern in accordance with one illustrative embodiment;

FIG. 13 is an example diagram illustrating an enqueuing instruction for generating a right alignment pattern in accordance with one illustrative embodiment;

FIG. 14 is an example diagram illustrating a preferred use of the EnqueueLeft and EnqueueRight instructions in accordance with one illustrative embodiment;

FIG. 15 is an example diagram illustrating a preferred use of the EnqueueLeft and EnqueueRight instructions in accordance with an alternative illustrative embodiment;

FIG. 16 is a block diagram illustrating a compiler optimization in accordance with one illustrative embodiment;

FIG. 17 is a flowchart outlining an exemplary operation for compiling source code into executable code in accordance with one illustrative embodiment;

FIG. 18 is an example of code, corresponding to the code illustrated in FIG. 8, but using the new instructions for utilizing the permute logic and counter logic of the illustrative embodiments; and

FIG. 19 is a flowchart outlining an example operation for generating enqueued data for a conditional branch within a loop in accordance with one illustrative embodiment.

### DETAILED DESCRIPTION

The illustrative embodiments provide mechanisms for efficiently enqueuing data in vector registers of a single-instruction-multiple-data (SIMD) processor architecture that utilizes a permute unit. With the mechanisms of the illustrative embodiments, existing hardware units in a SIMD processor architecture may be used to determine which data values input to a branch instruction will result in the branch being taken and then control the computations within the branch so that they are only performed for those data values that would result in the branch being taken. The mechanisms of the illustrative embodiments leverage the use of the existing load/store units and queues, a permute unit, and the vector registers of the SIMD processor architecture to facilitate the selection of data values resulting in a branch being taken and then storing these data values in vector registers such that they may be used to control computations within the branch.

With the mechanisms of the illustrative embodiments, a predicate vector register is used to store the result of a compare performed by a SIMDized code loop to determine, for input data elements, whether a condition of a branch is true or false. The values in the predicate vector register are used to generate a mask stored in a mask register. The mask identifies the SIMD vector slots in the predicate vector register that have a true value, or in an alternative embodiment, the predicate vector registers that have a false value. The resulting mask in the mask vector register is input to a permute unit along with the data values in an input data vector register. The permute unit, based on these inputs, outputs a vector register in which the vector slots store only the data values of the vector slots in the input data vector register corresponding to the mask in the mask vector register, i.e. the output vector register stores only the data values that would result in the branch being taken.

The output vector register values may be stored in memory in an aligned or unaligned manner such that they may be used to control the computations within the branch. In this way, only the data elements for which the branch would be taken will be the basis upon which the computations are performed. As a result, the wasted computations, processing cycles, and resources discussed above are avoided by the use of the illustrative embodiments.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

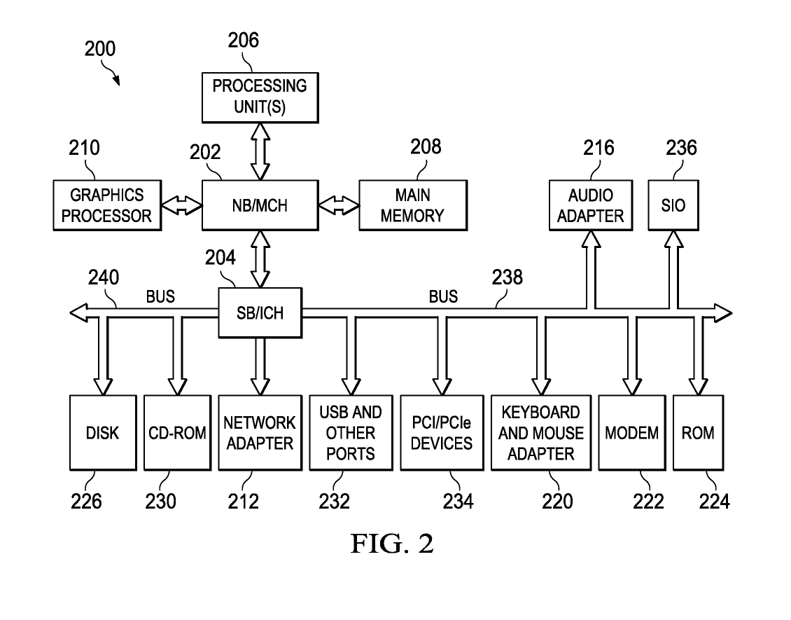

With reference now to FIG. 2, an exemplary data processing system is shown in which aspects of the illustrative embodiments may be implemented. Data processing system 200 is an example of a computer in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NR/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

With the data processing system 200 of FIG. 2, the processor 206 may have facilities for processing both integer (scalar) and floating point (vector) instructions and operating on both types of data. However, in accordance with the illustrative embodiments, the processor 206 may have hardware facilities for handling SIMD instructions and data as floating point only SIMD instructions and data. The scalar facilities are used for integer processing, and in conjunction with the floating point only SIMD architecture for inter alia loop control and memory access control.

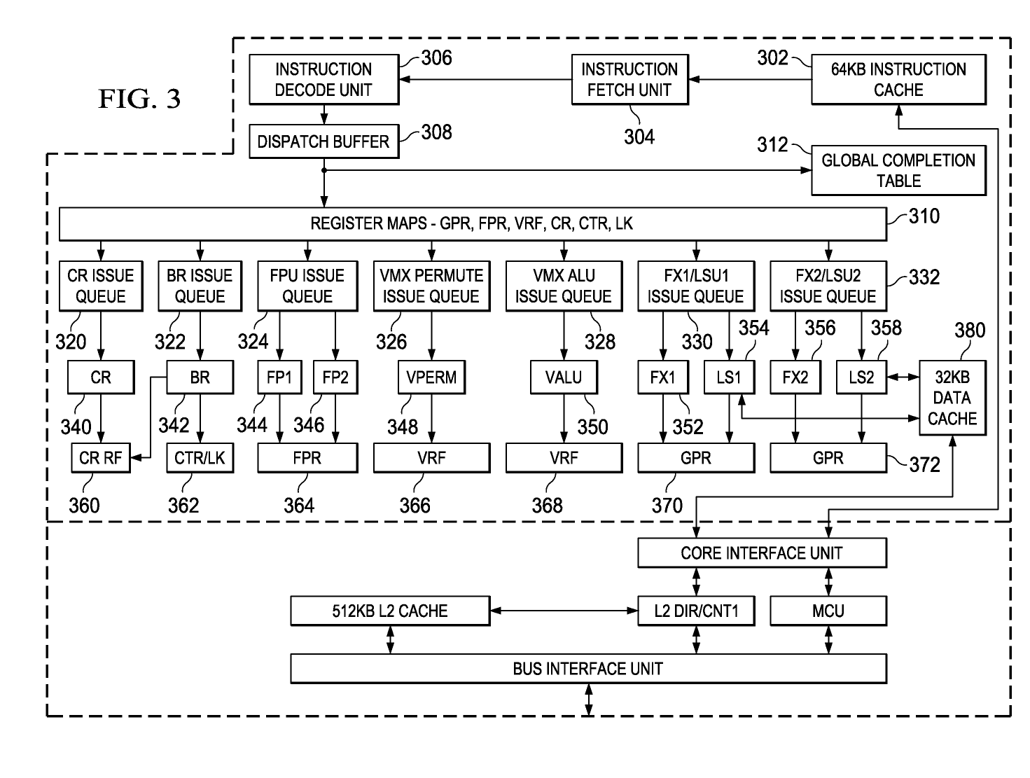

FIG. 3 is a block diagram of a processor architecture shown for purposes of discussion of the improvements made by the floating point only single instruction multiple data (SIMD) instruction set architecture (ISA) of the illustrative embodiments. As shown in FIG. 3, the processor architecture includes an instruction cache 302, an instruction fetch unit 304, an instruction decode unit 306, and a dispatch buffer 308. Instructions are fetched by the instruction fetch unit 304 from the instruction cache 302 and provided to the instruction decode unit 306. The instruction decode unit 306 decodes the instruction and provides the decoded instruction to the dispatch buffer 308. The output of the decode unit 306 is provided to both the register maps 310 and the global completion table 312. The register maps 310 map to one or more of the general purpose registers (GPRs), floating point registers (FPRs), vector register files (VRF), and the like. The instructions are then provided to an appropriate one of the issues queues 320-332 depending upon the instruction type as determined through the decoding and mapping of the instruction decode unit 306 and register maps 310. The issue queues 320-332 provide inputs to various ones of execution units 340-358. The outputs of the execution units 340-358 go to various ones of the register files 360-372. Data for use with the instructions may be obtained via the data cache 380.

Of particular note, it can be seen in the depicted architecture that there are separate issue queues and execution units for floating point, vector, and fixed point, or integer, instructions in the processor. As shown, there is a single floating point unit (FPU) issue queue 324 that has two output ports to two floating point execution units 344-346 which in turn have output ports to a floating point register file 264. A single vector permute issue queue 326 has a single output port to a vector permute execution unit 348 which in turn has a port for accessing a vector register file (VRF) 366. The vector arithmetic logic unit (ALU) issue queue 328 has one issue port for issuing instructions to the vector ALU 350 which has a port for accessing the vector register file 368. It should be appreciated that these issue queues, execution units, and register files all take up resources, area, and power.

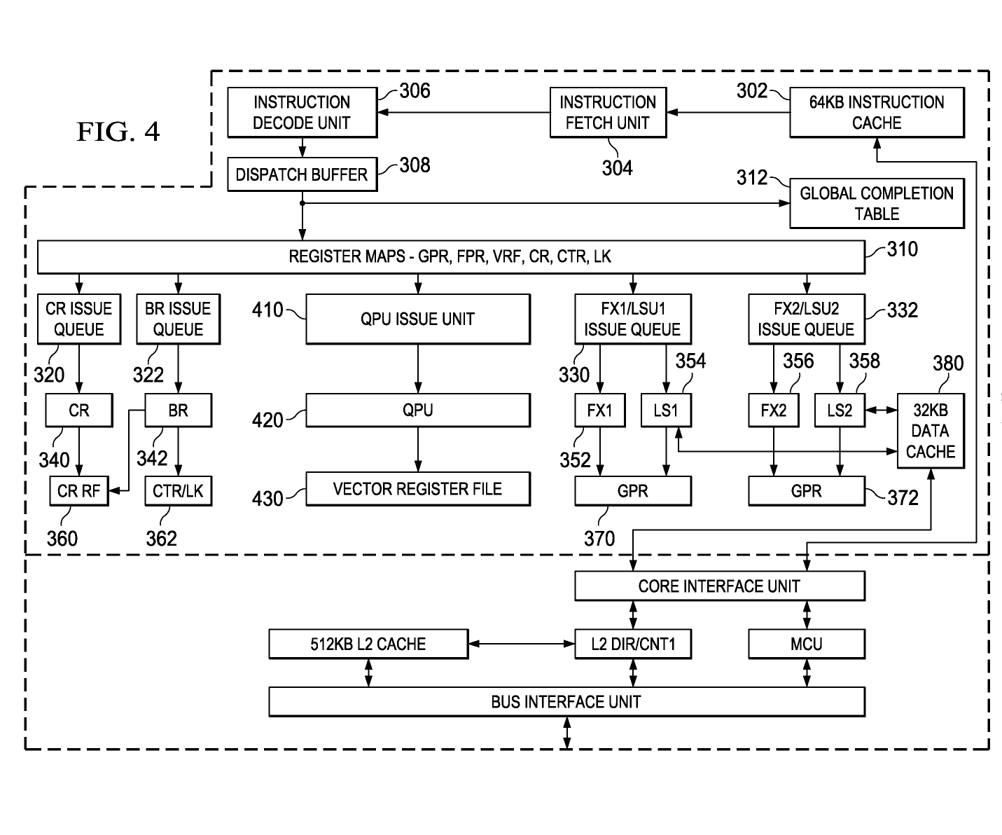

The vector permute execution unit 348 operates to provide a mechanism for rearranging the data elements in the slots of a vector register. That is, based on one or more input vectors, and a control input, the vector permute execution unit 348 can rearrange the data elements of the one or more vectors such that they are in different slots of a resulting vector register. The permute operation will be described in greater detail hereafter with regard to the permute functionality provided in an alternative embodiment illustrated in FIG. 4.

FIG. 4 is an alternative example processor architecture in which the illustrative embodiments of the present invention may be implemented. The architecture shown in FIG. 4 is an example of a floating point (FP) only SIMD processor architecture in which the issue units 324-328, the execution units 344-350, and register files 364-368 in FIG. 3 are replaced with a single issue queue, execution unit, and register file. An example of the processor architecture in FIG. 4 and corresponding instruction set architecture (ISA) is described in commonly assigned and co-pending U.S. patent application Ser. No. 12/834,464, which is hereby incorporated by reference.

The processor architecture shown in FIG. 4 is of a modified form of the architecture shown in FIG. 3 and thus, similar elements to that of FIG. 3 are shown with similar reference numbers. It should be appreciated that the example modified architecture is only an example and similar modifications can be made to other processor architectures to reduce the number of issue units, execution units, and register files implemented in these other architectures. Thus, the mechanisms of the illustrative embodiments are not limited to implementation in a modified form of the processor architecture of FIG. 3. Moreover, other types of vector processor architectures may be used to implement the mechanisms of the illustrative embodiments as long as the architecture provides logic for implementing a permute functionality as described hereafter.

As shown in FIG. 4, the modified architecture shown in FIG. 4 replaces the issue units 324-328 with a single quad-processing execution unit (QPU) issue unit 410. Moreover, the execution units 344-350 are replaced with the single quad-processing execution unit (QPU) 420. Furthermore, the register files 364-368 are replaced with a single quad-vector register file (QRF) 430. Because the quad-processing unit (QPU) can execute up to 4 data elements concurrently with a single instruction, this modified architecture not only reduces the resource usage, area usage, and power usage, while simplifying the design of the processor, but the modified architecture also increases performance of the processor.

It should be noted that the modified processor architecture in FIG. 4 still has the fixed point units (FXUs) which process scalar integers. Such scalar integers are used primarily for control operations, such as loop iterations, and the like. All other instructions are of the floating-point or vector format. Specifically, unlike the mixed floating point and integer execution repertoire of the VMX instruction set, the QPX instructions generally operate, and in particular perform arithmetic operations, on floating point data only. The only storage of integer-typed data is associated with conversion of data to an integer format for the purpose of loading and storing such integers, or moving a control word to and from the floating point status and control register (FPSCR). Reducing operations to a floating point-only format greatly enhances efficiency of floating point processing, as an appropriate internal representation optimized for the representation and processing of floating numbers can be chosen without regard to the needs of integer arithmetic, logical operations, and other such operations.

In accordance with one illustrative embodiment, with the floating-point only SIMD ISA, there is no requirement to support integer encoding for the storage of comparison results, Boolean operations, selection operations, and data alignment as is required in prior known ISAs. The floating-point (FP) only SIMD ISA allows substantially all of the data to be stored as floating point data. Thus, there is only one type of data stored in the vector register file 430 in FIG. 4.

In accordance with an illustrative embodiment, the FP only SIMD ISA provides the capability to compare floating point vectors and store comparison results in a floating point vector register of the vector register file 430. Moreover, the FP only SIMD ISA provides an encoding scheme for selection operations and Boolean operations that allows the selection operations and Boolean logic operations to be performed using floating point data representations.

In one illustrative embodiment, the FP only SIMD ISA uses an FP only double precision SIMD vector with four elements, i.e., a quad-vector for quad-execution by the QPU 420. Single precision SIMD vectors are converted automatically to and from double precision during load and store operations. While a double precision vector SIMD implementation will be described herein, the illustrative embodiments are not limited to such and other precisions including, but not limited to, single precision, extended precision, triple precision, and even decimal floating point only SIMD, may be utilized without departing from the spirit and scope of the illustrative embodiments.

In one illustrative embodiment, the mechanisms of the illustrative embodiment for implementing the FP only SIMD ISA are provided primarily as logic elements in the QPU 420. Additional logic may be provided in one or more of the memory units LS1 and LS2 as appropriate. In other illustrative embodiments, the mechanisms of the illustrative embodiments may be implemented as logic in other elements of the modified architecture shown in FIG. 4, such as distributed amongst a plurality of the elements shown in FIG. 4, or in one or more dedicated logic elements coupled to one or more elements shown in FIG. 4. In order to provide one example of the implementation of the illustrative embodiments, it will be assumed for purposes of this description that the mechanisms of the illustrative embodiments are implemented as logic in the QPU 420 unless otherwise indicated.

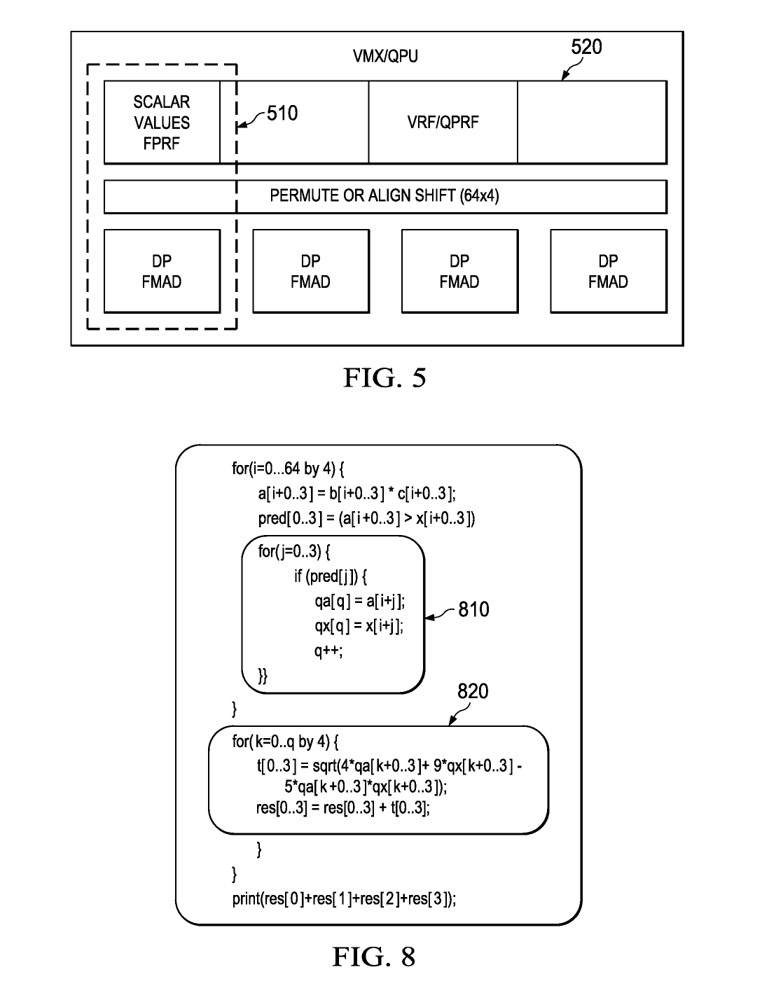

As discussed above, in the some illustrative embodiments, a quad-processing architecture is utilized in which a quad-processing unit (QPU) 420 can execute up to 4 data elements concurrently with a single instruction. This quad-processing architecture is referred to as the Quad-Processing extension architecture (QPX). In one illustrative embodiment, the QPX architecture utilizes a four data element double precision SIMD architecture which is fully compliant with the PowerPC scalar computation architecture. That is, as shown in FIG. 5, a legacy scalar ISA is overlaid on the floating point vector SIMD ISA of the illustrative embodiments such that legacy instructions may be executed using the vector registers of the illustrative embodiments. Legacy scalar instructions operate on a preferred slot 510, i.e., a well defined element position in the vector of the vector registers 520. For such scalar instructions, and data values, the other slots of the vector may be set to zero, left undefined, set to another well defined value, or the like. These are basically “don't care” slots with regard to the scalar instructions.

By establishing a preferred slot 510 for scalar instructions, data sharing between scalar and vector instructions is obtained. Thus, there is no need for conversion operations for converting between scalar and vector data values as with known ISAs. Moreover, both scalar and floating point vector instructions and values may be stored in the same vector register file, e.g., vector register file 330 in FIG. 3. This eliminates the need for a separate scalar floating point unit and vector floating point unit while still allowing scalar instructions to be executed.

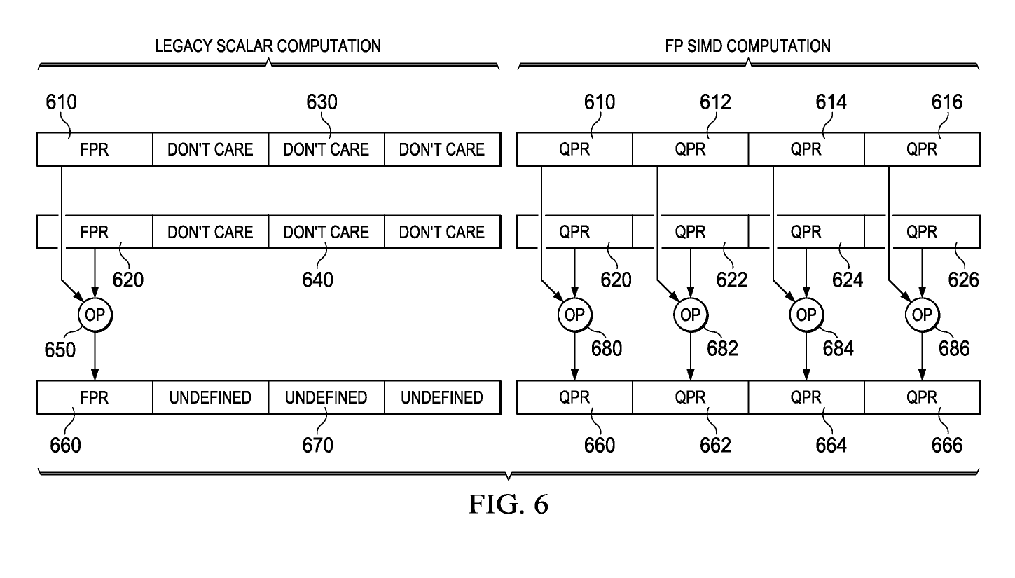

FIG. 6 shows how the same vector registers may be used to perform legacy scalar computation operations as well as vector computation operations. As shown in FIG. 6, for scalar computation operations, the preferred slots 610 and 620 of the vector registers 630 and 640 in the vector register file, e.g., vector register file 330, are operated upon by the scalar instruction or operation 650 with the scalar result being stored in the preferred slot 660 of vector register 670. The other slots 612-616 and 622-626 of the vector registers 630 and 640 are “don't care” slots and are not used by the scalar instruction. As mentioned above, these slots may have values that are set to zero, some well defined value, the value in slots 610 and 620 may be replicated to the remaining slots in their corresponding register, or the like.

With floating point vector instructions, instructions are able to perform four operations 680-686 on respective ones of the slots 610-616 and 620-626 of the vector registers 630 and 640. The results of these vector instructions 680-686 are written to corresponding slots 660-666 of the vector register 670. Thus, both scalar instructions and vector instructions may be executed by a quad-processing unit (QPU), such as QPU 420 in FIG. 4, using the vector registers of the vector register file 430, for example. This greatly reduces the area, power, and resource consumption of the processor architecture.

In addition to the above, the floating point only SIMD ISA of the illustrative embodiments further provides a permute functionality on the quad-processing vector register data values. The permute function or operation is performed at the vector element granularity on naturally aligned vector elements. The permute functionality in the QPU 420 is implemented in such a way as to support an all-to-all permutation. That is, any of the elements of two input vector registers may be selected for storage in any of the first through fourth elements of a result vector register. The selection of which vector register element is to be used for each slot of the result vector register is controlled by a control value which is also a floating point vector value.

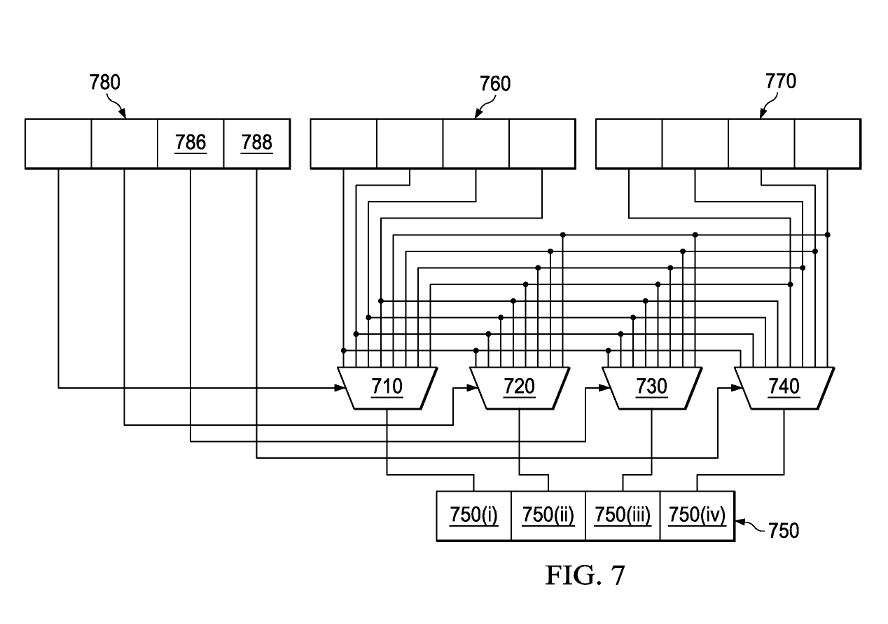

FIG. 7 is an exemplary diagram of the permutation logic for a quad-processing unit in accordance with one illustrative embodiment. As shown in FIG. 7, four multiplexers 710-740 are provided. Each multiplexer 710-740 outputs one of the input vector register elements as an output to a corresponding one of the vector elements in result vector register 750. In the depicted embodiment, each multiplexer 710-740 has eight inputs, one from each of the four elements of the vector registers 760 and 770. A third vector register 780 provides the control input to the multiplexers 710-740. That is, each element 782-788 is input to a respective one of the multiplexer 710-740 and identifies which input to output to the result vector register 750. The third vector register 780, is also part of the vector register file along with vector registers 760 and 770 and thus, has a similar configuration as described herein.

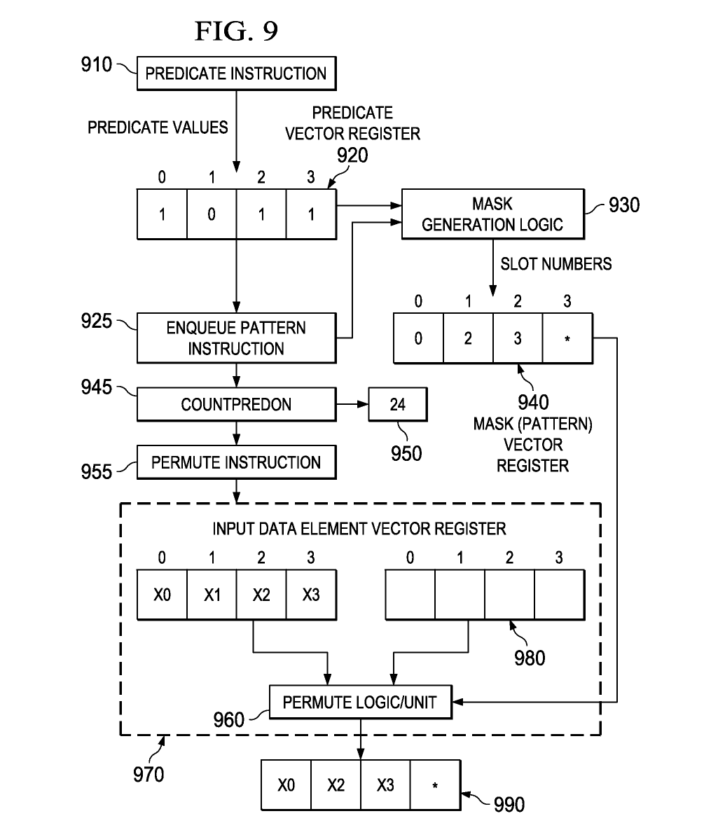

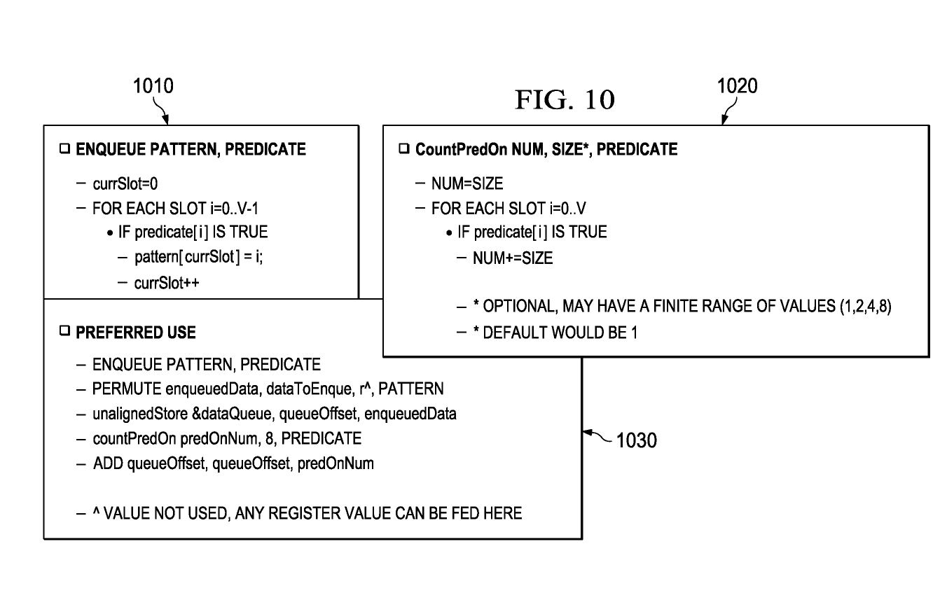

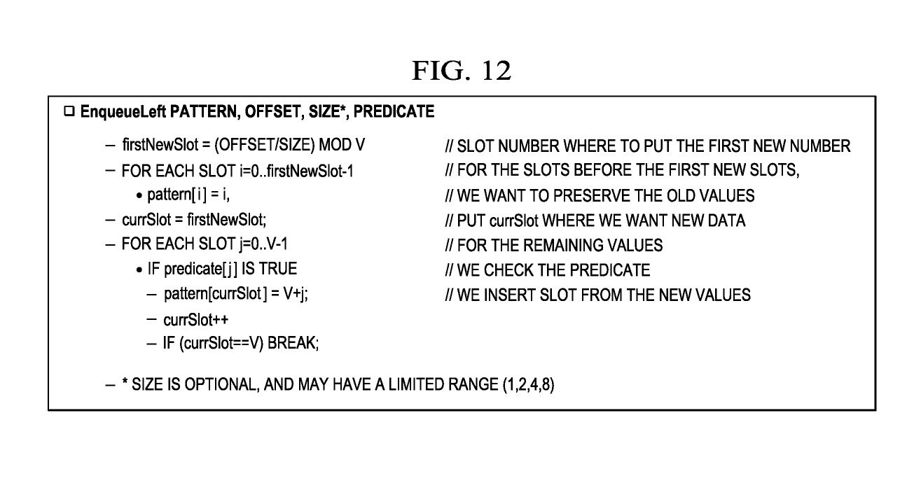

Thus, with the permutation logic of FIG. 7, the permute instruction of the floating point only SIMD ISA may select from two source vectors, any of the elements to generate one target vector. Operations are provided for constructing a control vector and storing that control vector in a vector register, such as vector register 780 in FIG. 7. In one illustrative embodiment, instructions for performing such operations are adapted to construct the control vector as a floating point vector from a literal, i.e. an immediate value field in the instruction word (e.g., see qvgpci instruction in FIG. 12, described hereafter), encoded in the instruction word. In another illustrative embodiment, instructions are adapted to construct the control vector as a floating point vector from an address specified as an operand to the instruction (for example, see the qvlpcldx and qvlpclsx instructions of FIGS. 9 and 10 which read registers ra and rb and convert them into control words stored in the qalign register, described hereafter). In either case, the control vector represents the permutation pattern for rearranging the data from one or more input vectors to generate an output data vector in an output vector register.

Thus, a FP-only SIMD ISA processor, data processing system, apparatus, or the like, such as that described in the illustrative embodiments herein, comprises at least a floating point vector register file containing at least two floating point vector register elements in a single floating point vector register and a permute unit receiving at least two input operands containing data to be permuted and at least one control vector indicating the permutation pattern as a floating point vector. The permute functionality of the permute unit supports an all-to-all permutation in which any of the floating point vector register elements of the two input floating point vector registers may be selected for storing in any floating point vector register element of a result floating point vector register. Selection of which floating point vector register element of the result floating point vector register is to be used is controlled by a floating point vector control value of the control vector. The floating point vector control values of the control vector specify a permutation pattern. The permutation pattern is, in one illustrative embodiment, a floating point vector encoded by way of high-order mantissa bits and a well-defined exponent value, as described hereafter.

In one illustrative embodiment, the floating point representation of the floating point vector values for the permute control vector is chosen to correspond to numbers having only a single possible representation. In another illustrative embodiment, the floating point representation of the floating point vector values for the permute control vector is chosen to correspond to numbers not requiring preprocessing to determine the control action of the permute unit. The permute instruction, that invokes the operation of the permute unit, is adapted to permute single and double precision values stored in the respective one of each vector locations directly.

The logic of the permute unit, as shown in the illustrative embodiment of FIG. 7, comprises one or more multiplexers, e.g., four multiplexers in the depicted example, each of the one or more multiplexers outputting a floating point value selected from floating point values of the at least two floating point vector register elements, as an output to a corresponding one of the floating point vector register elements in the result floating point vector register. The floating point vector register elements may represent input operands, for example. The vector elements of the control vector indicate the permutation pattern as a floating point vector that encodes the source of the floating point number. For example, with regard to the example of FIG. 7, the control vector 780, and more specifically its specific elements 782, 784,786, and 788, encode the source information for each of the elements 750(i), 750(ii), 750(iii), and 750(iv). Element 780 (and specifically the slots 782, 784, 786 and 788) of FIG. 7 represent an alignment control vector that, as a software register, is specified by the register name qalign. Register 780 (register qalign) consists of 4 vector element slots each encoding the source to be selected by multiplexers 710 through 740 in accordance with FIG. 7.

Regardless of whether separate vector permute units are utilized, as shown in FIG. 3 for example, or the vector permute logic is integrated into a vector execution unit, such as the quad-processing unit (QPU) shown in FIG. 4 for example, the illustrative embodiments leverage the functionality of the vector permute logic to assist in reducing the computation required for embedded conditional branches within code loops. Essentially, the illustrative embodiments utilize predicate register values to generate a mask value that is used as the control vector input to the vector permute logic. This mask value specifies which vector slots of the input data vectors correspond to data values for which the conditional branch is determined to be “taken,” i.e. the condition of the branch is resolved to be “true.” The slot numbers that are stored in the mask register are written consecutively in the mask register for each vector slot in the predicate register that has a “true” value (it should be appreciated that the same can be done in an alternative embodiment in which the predicate register for “false” values, essentially reversing the operation). The vector permute logic then outputs the resulting output vector which comprises the data values from the vector slots of the input data vectors that correspond to data values for which the conditional branch is determined to be taken.

In the above embodiment, instructions are used that take a predicate as input and generate a mask to be used by an unmodified permute unit. This approach has the advantage of not modifying a permute unit whose cycle time is often critical. The permute operation is also unusually expensive in terms of opcode, i.e. each instruction is identified by the hardware by a unique number, augmented by the identifiers necessary to describe which registers are used as input, and which register, if any, are used as output. In most architectures, there is a fixed number of bits that can be used to describe the instruction along with its registers, e.g., 32 bits. The reason why the permute instruction is an expensive unit in terms of opcodes is that the permute instruction uses 3 input registers and 1 output register. Given that there are 32 registers in the particular example architecture, 5 bits are used to describe the identifier of one register. Thus 4 times 5 bits=20 bits of the 32 bits are used to describe registers. As a result, in one illustrative embodiment, a few more instructions that use only 2 input registers and one output register (requiring only 15 bits for describing the registers) are utilized. Thus, this approach is more economical in terms of the fraction of the total number of instructions plus register identifiers that can be represented within a fixed number of bits.

In an alternative embodiment, the permute unit may be modified so as to also accept a predicate register as input, as opposed to a mask indicating how to permute the input values. In doing so, the mask does not need to be constructed with a special mask-generating operation and as a result, a savings in terms of the instructions that are needed at runtime to complete the desired sequences of instructions is obtained. In doing so, however, additional 3 input, 1 output instructions are added that are expensive in terms of opcode space. Depending on the number of instructions required on the target architecture, there may or may not be sufficient space in the opcode space to accommodate such a permute with predicate register input instead of a regular mask as described in FIG. 7.

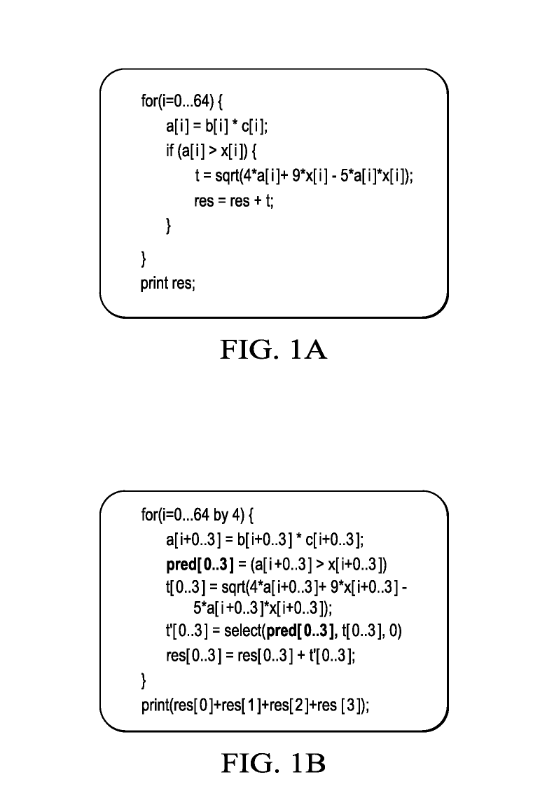

Having identified which data values correspond to the conditional branch having been taken by using the permute unit in the manner described above, the output of the permute unit may be used to perform the calculations of the “then” clause of the “if” conditional branch in the code. That is, rather than having to calculate the value for t in the examples of FIGS. 1A and 1B above for all i values 0 to 63 even if the “if” branch is not taken, the output of the permute unit may be used to cause the calculation of the t value to be performed only for those data elements, or iterations i, for which the “if” branch has been determined to be taken. This reduces wasted computation, processor cycles, and resources. For example, if it is assumed that the “if” branch in FIGS. 1A and 1B is only taken 50% of the time, by use of the present invention, 50% of the computation, processor cycles, and resources may be conserved.

With reference again to FIGS. 1A and 1B above, what one would want to do to avoid the wasted computations, processor cycles, and resources in the implementation of code shown in FIG. 1B is to identify the iterations i that result in the predicate value pred[0 . . . 3] indicating the condition to be satisfied, i.e. the branch to be taken. One way in which to do this is to rewrite the code in a manner such as that shown in FIG. 8. The code in FIG. 8 essentially splits the “for” loop by including additional code portion 810 that identifies iterations of the “for” loop for which the predicate condition is determined to be “true” and code portion 820 which performs the “then” computation of the “for” loop only on the iterations of the “for” loop for which the predicate condition is determined to be “true.”

That is, as shown in FIG. 8, the SIMDized code in FIG. 1B is modified to include additional code portions 810 and 820 to identify the predicate values that indicate the condition to have been satisfied (portion 810), i.e. a “true” value, and then iterate over these “true” values to calculate the t value (portion 820). Essentially, the code first computes predicate values indicating whether the “if” branch condition is true or false. Then, in portion 810, these predicate values are evaluated and if the predicate value is true, then the values of a[i+j] and x[i+j] are enqueued in values qa[q] and qx[q]. Thereafter, in portion 820, for each value enqueued in qa[q] and qx[q], the value oft is calculated.

It should be appreciated that the code portion 810 that iterates over the vector slots to determine if the predicate is true or false and then enqueues the a[i+j] and x[i+j] is very slow to execute. That is, in the depicted example, the code in 810 is sequential and not executed in a SIMD manner. Thus here alone one needs 4 times more operations than if the portion of code 810 were executed in a SIMD manner for the target architecture. In addition, the code sequence has a branch, i.e. an instruction that requires predicting the target program counter in a modern processor pipeline. When the prediction is false (e.g., the branch predictor predicted the branch to be taken, when in fact the branch ended up being not taken), the instructions that were falsely fetched, possibly decoded, and possibly executed need to be removed from the pipeline and the correct instructions need to be fetched, decoded and executed. Further, each iteration of the loop in code segment 810 is dependent on the previous iteration, as the value of q may be incremented in one iteration and this new value may be used in the next iteration. As described hereafter, the mechanisms of the illustrative embodiments provide an alternative for performing the functionality of the code portion 810 that does not suffer from the drawbacks of the code 810 described above.

FIG. 9 is an example block diagram illustrating the primary operational elements in accordance with one illustrative embodiment. The illustrative embodiment depicted in FIG. 9 assumes a processor architecture in which vector registers have four vector register slots and the architecture can process an instruction on four data elements in a parallel manner. In other words, the illustrative embodiments assume a simultaneous multithreaded (SMT) 4 SIMD architecture. It should be appreciated, however, that the illustrative embodiments may be employed with other vectorized or SIMDized architectures able to process more or less numbers of threads and data elements in a parallel manner without departing from the spirit and scope of the illustrative embodiments. It should further be appreciated that FIG. 9 is only intended to represent one example logical sequence of instructions and is not intended to represent the actual data value paths. Many modifications to the example shown in FIG. 9 may be made without departing from the spirit and scope of the illustrative embodiments.

As shown in FIG. 9, a predicate instruction 910 is executed in a normal manner to generate a plurality of predicate values by evaluating a condition of a conditional branch for a plurality of iterations and data elements, e.g., 4 iterations and data elements. A predicate instruction is namely an instruction whose result is used as a predicate. Predicate instructions are typically compare instructions, e.g., such as in FIG. 8 where the values of a[i+0 . . . 3] are compared to the values x[i+0 . . . 3] and where a true result is determined if each of the four “a” values are strictly larger than their corresponding “x” value. Predicate instructions can also be logical instructions that combine, for example, the result of two compare instructions. For example, if a conditional needs to determine if a[i+0 . . . 3]>10 or a[i+0 . . . 3] <=0, the compares would be performed to determine the “larger than 10” and “smaller or equal to zero” and then use a logical operation or instruction to combine the two predicates into a single predicate that is true if either of the two original predicates are true.

The execution of the predicate instruction 910 causes the predicate values to be written to corresponding vector slots in the predicate vector register 920. In the depicted example, it is assumed that a first iteration of the loop, and corresponding first data element, results in the “if” branch, which is now represented by the predicate instruction, being taken. Similarly, the third and fourth iterations and data elements result in the branch being taken as well. The second iteration and data element results in the branch not being taken. Thus, the predicate vector register 920 stores the values 1, 0, 1, 1.

An enqueue pattern instruction 925 is executed that causes mask generation logic 930 to generate a set of mask values stored in a mask vector register 940 based on the predicate vector register 920. The mask generation logic 930 stores the vector slot number of the vector slots in the predicate vector register 920 that have values indicating that the branch is taken, i.e. vector slots in the predicate vector register 920 that have a “1.” The vector slot numbers are written to the mask vector register 940 in a consecutive manner. Thus, if less than four vector slots in the predicate vector register 920 have a “1”, then not all of the vector slots in the mask vector register 940 will have a slot number written to them. Any vector slots of the mask vector register 940 that do not have a specific slot number written to them are filled with a “don't care” value represented by the “*” in FIG. 9.

A CountPredOn instruction 945 is executed to cause a counter 950 to be incremented based on the number of “true” values in the predicate vector register 920 and the size of the data elements, e.g., 8 bytes. Thus, in the depicted example, assuming 8 byte data elements, the counter 950 is incremented by 24 since three vector slots in the predicate vector register 920 store “1s” indicating the condition of the branch is resolved to a “true” value, indicating that the branch is to be taken for that iteration/data element.

A permute instruction 955 may then be executed to cause the mask stored in the mask vector register 940 to be input to a permute unit, or permute logic 960 as the control vector to the permute unit. In addition, the data element input vector registers 970-980 also provide data elements as input to the permute unit/logic 960. The data elements correspond to the data elements for which the predicate instruction evaluated the condition of the branch. In the depicted example, since only four data elements are evaluated at a time (see the code example in FIGS. 1B and 8), only one of the data element input vector registers 970 contains actual data element values while the other data element input vector register 980 is unused or stores “don't care” values.

The permute unit/logic 960 selects the data elements from data element input vector registers 970-980 corresponding to the vector slot numbers stored in the mask vector register 940. Thus, in this case, data element x0 is selected from vector slot 0 of the data element input vector register 970 in accordance with the slot number 0 stored in the mask vector register 940. Similarly, the data elements x2 and x3 are selected from vector slots of the data element input vector register 970 in accordance with the vector slot numbers stored in the mask vector register 940.

The value stored in the counter 950 is used to provide an offset into memory 990 where the data elements output by the permute unit/logic 960 are stored, i.e. an offset to where the output vector register is provided in the memory 990. The output data elements may be stored in the memory 990 in an unaligned or aligned manner, i.e. aligned with alignment boundaries of a predetermined size, e.g., 32 bytes. As is generally known in the art, some processor architectures require memory accesses to be aligned, i.e. each memory access is of a predetermined size and thus, alignment boundaries are established according to this predetermined size. Examples of aligned and unaligned memory access embodiments of the illustrative embodiments will be provided hereafter.

FIG. 10 illustrates the Enqueue and CountPredOn instructions as well as the preferred use of these instructions with the permute and store instructions for an unaligned memory access processor architecture. As shown in FIG. 10, the Enqueue instruction 1010 receives as input the predicate values from a predicate register and outputs a pattern, or mask. The functionality of the Enqueue instruction 1010 involves initializing the current slot to 0 and then for each slot in the predicate register from 0 to V-1 (where V is a size of vector registers for the particular processor architecture), a determination is made as to whether the value in the slot is true or not. If the value is true, then the pattern vector register value for the current slot is set equal to the value of the slot i. The current slot value is then incremented.

The CountPredOn instruction 1020, which is used to increment the counter based on the number of “true” values in the predicate register, receives the predicate register values as input and the current size of each vector slot, e.g., 4 bytes, 8 bytes, or the like. The counter value num is set equal to zero and then for each slot in the predicate vector register, if the predicate value in the slot of the predicate vector register is “true,” then the counter value num is incremented by the size.

With these two new instructions, which make use of the mask generation logic and counter logic illustrated in FIG. 9 above, a preferred use of these instructions is shown in element 1030 in FIG. 10. As shown in element 1030 of FIG. 10, assuming that a predicate instruction has already been executed in a normal fashion such that a predicate vector register has been populated with predicate values for a set of iterations of a loop, the Enqueue instruction is first executed following by a standard permute instruction. The Enqueue instruction generates a pattern based on the predicate values in the predicate vector register.

The permute instruction receives as input the data to enqueue (dataToEnque), i.e. the input data elements from the input data element vector register, a blank or “don't care” register r*, and the pattern generated by the Enqueue instruction. The blank or “don't care” register r* is not actually used by the permute unit/logic and any register value can be fed into the permute instruction here.

The permute instruction generates the enqueued data (enqueuedData) that corresponds to the output of the permute unit/logic in FIG. 9. An unaligned store of the enqueued data is performed using the queue offset determined according to the counter value. The counter value is then updated using the countPredOn instructions and the updated counter value is used to update the queue offset value.

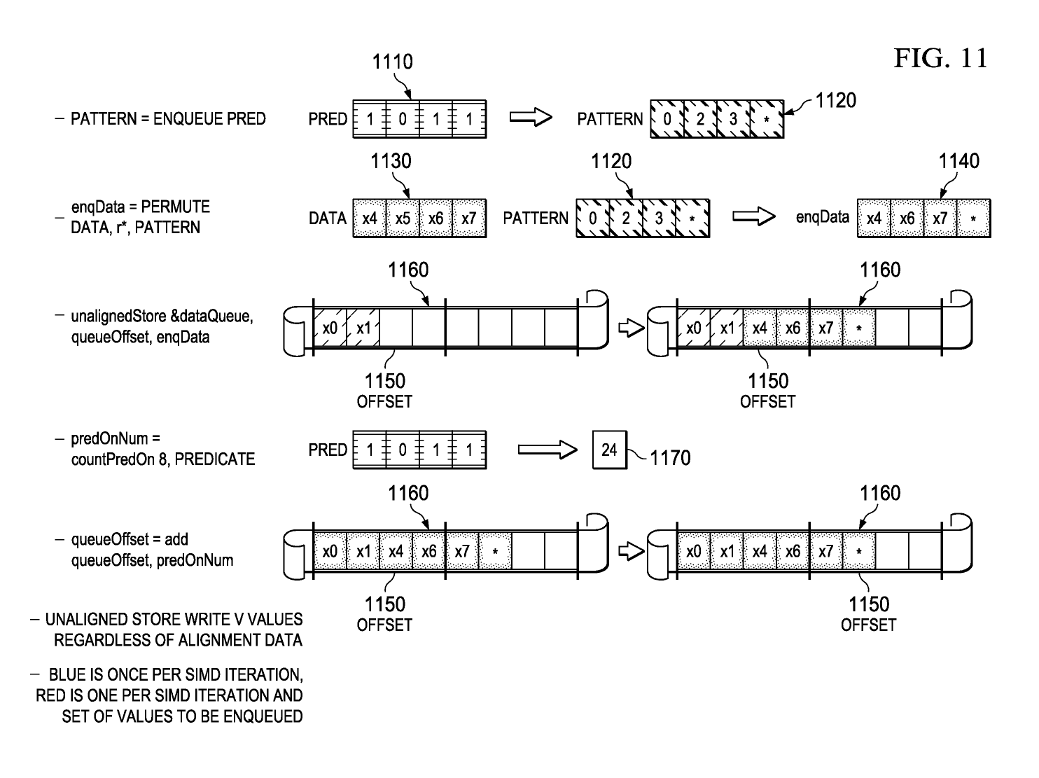

FIG. 11 illustrates an example operation of the preferred implementation of the Enqueue instruction and countPredOn instructions in the manner shown in FIG. 10. As shown in FIG. 11, the “enqueue pattern, predicate” instruction causes the pattern 1120 to be generated based on the predicate register values 1011. In this case, since slots 0, 2, and 3 have “true” values, i.e. “1”, stored in them, the pattern 1120 comprises values 0, 2, and 3 in slots 0, 1, and 2 of the pattern or mask vector register 1120 with the last slot storing a “don't care” value.

The “permute enqueueData, datatoEnqueu, r*, pattern” instruction causes the enqued data (enqData) to be generated based on the data to enqueue, or input data element vector register 1130, and the pattern 1120. In the depicted example, the pattern 1120 indicates that values in slots 0, 2, and 3 of the input data element vector register 1130 are to be enqueued as the output of the permute unit/logic. Thus, the enqData vector register 1140 is comprised of data elements x4, x6, x7, and a “don't care” value. This is the data that needs to be written to memory so that it may be used to perform the calculations in the “then” portion of the conditional branch.

In the depicted example, the enqueued data in the enqData vector register 1140 is written to memory using an unaligned store instruction. The enqueue data in enqData vector register 1140 is written to the memory regardless of alignment at the next memory location corresponding to an offset value 1150. In the depicted example, data elements x0 and x1 are already stored in the memory 1160 and thus, the offset value 1150 initially points to the memory location right after the x1 data element. As a result, the enqData vector register 1140 values are written to the memory locations starting at the offset value 1150 as shown such that the data elements in memory comprise x0, x1, x4, x6, x7, and a don't care value *.

The number of bytes of data (not including the “don't care” data) that was written to the memory 1160 is calculated using the countPredOn instruction. In this case, the counter value 1170 is set to 24 since each data element is 8 bytes in this example. Since there are 3 data elements corresponding to the 3 iterations whose “if” condition evaluates to “true,” the counter value is 3×8=24 bytes. This counter value 1170 is used by the add queueuOffset instruction to update the memory offset to point to the “don't care” value in the memory 1160 such that the next data element will be written to the memory 1160 at the same location as the “don't care” value effectively overwriting the “don't care” value.

As mentioned above, the writing of the data elements to the memory can be performed in an unaligned manner, such as illustrated in FIGS. 10 and 11 above, or in an aligned manner in processor architectures that require aligned memory accesses. In processor architectures that require aligned memory accesses, the generation of patterns and the enqueuing of the data based on the pattern is broken up into left and right alignment patterns and data enqueuing. An example of the use of the illustrative embodiments with aligned memory accesses is illustrated in FIGS. 12-14 hereafter.

The reason why the enqueueing of the pattern needs to be broken into two sub-patterns can be seen, for example, in FIG. 11. Consider the storing of the enqData 1140 in memory 1160. In FIG. 11, the 32 byte alignment are depicted by the vertical bold lines in 1160. When using an unaligned store, 32 bytes are written by one store regardless of where the first byte of these 32 needs to go to in memory. Namely, regardless of the address value modulo 32 (where the 32 correspond to the SIMD data width in byte for the example architecture). However, for machines that do not have unaligned memory operation, there are no operations that can write 32 bytes from arbitrary memory addresses. In such machines, one has only aligned memory operations, e.g., operations that write 32 bytes of data from memory locations that are only multiples of 32 bytes, i.e. from addresses that are 0 mod 32.

Consider again the example in FIG. 11. To write the data 1140 at offset 1150 using aligned memory operation, the architecture must perform 2 stores, one that stores the x4 and x6 values and one to store the x7 value. The architecture must use two stores because the bytes that are to be written into memory straddle a 0 mod 32 alignment address. Further, the architecture must first load the x0 and x1 value in memory, splice the xo and x1 values with the new values that are to be stored with the old x0 and x1 values, and once the splicing is done, the old and new values can be stored by one aligned store operation. Similar handling is needed for storing the x7 value. Now while one could substitute one unaligned store by two loads, one mask generation, two permute and two stores, this would be very slow and inefficient. The illustrative embodiments described herein, however, integrate the handling of the predicate, mask generation, permuting, and storing with the handling of the alignment as required when dealing with machines supporting only aligned memory operations.

FIG. 12 is an example diagram illustrating a enqueuing instruction for generating a left alignment pattern in accordance with one illustrative embodiment. The EnqueueLeft instruction receives as inputs the offset value, the predicate vector register values, and optionally a size of the data elements and returns a pattern for selecting data values. Initially, using the firstNewSlot instruction, the EnqueueLeft instruction determines the slot number of the pattern, or mask, vector register where the first new slot number from the predicate vector register is to be stored. Thereafter, for the slots of the pattern or mask vector register that are before the new slot location, the pattern values are simply set to the current value of the slot in order to make sure that the old values stored in memory are preserved. The current slot value is then set to the slot where the new slot values are to be stored and then, for each slot from the current slot to the end of the pattern or mask vector register, the predicate value for the corresponding slot in the predicate vector register is checked and if it is a “true” value, then the slot number is inserted into the slot of the pattern or mask vector register.

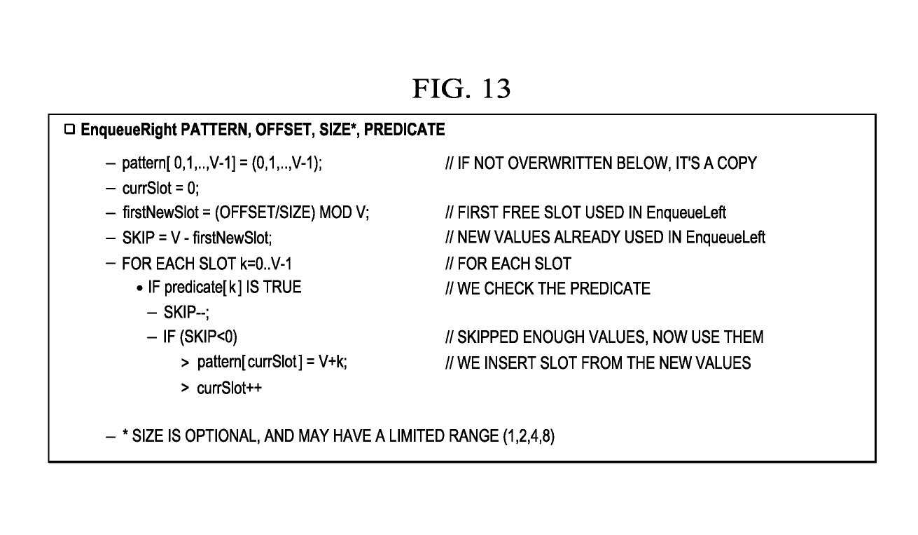

FIG. 13 is an example diagram illustrating an enqueuing instruction for generating a right alignment pattern in accordance with one illustrative embodiment. The EnqueueRight instruction again takes as inputs the offset value, the predicate vector register values, and optionally a size of data elements and returns a pattern for selecting data values. The pattern is initially set to a series of slot numbers corresponding to the pattern that makes the permute unit simply copy to the output register the content of the first of the two input registers. Thereafter, the current slot value is set to 0 and the first free slot used in the EnqueueLeft instruction is determined. The new values already used in EnqueueLeft instruction are skipped in the predicate vector register and then, for each subsequent slot, a determination is made as to whether the predicate vector register value is a “true” value. If the value is “true”, then the slot number associated with this value is used. The skipping of the new values already used by the EnqueueLeft is shown in FIG. 13 by initializing the “skip counter” value to the number of values to skip and then decrementing the “skip counter” value each time that a new value is encountered. Once the “skip counter value” is smaller than zero, then a sufficient number of values have been skipped and the pattern is then updated so as to include the value in the pattern.

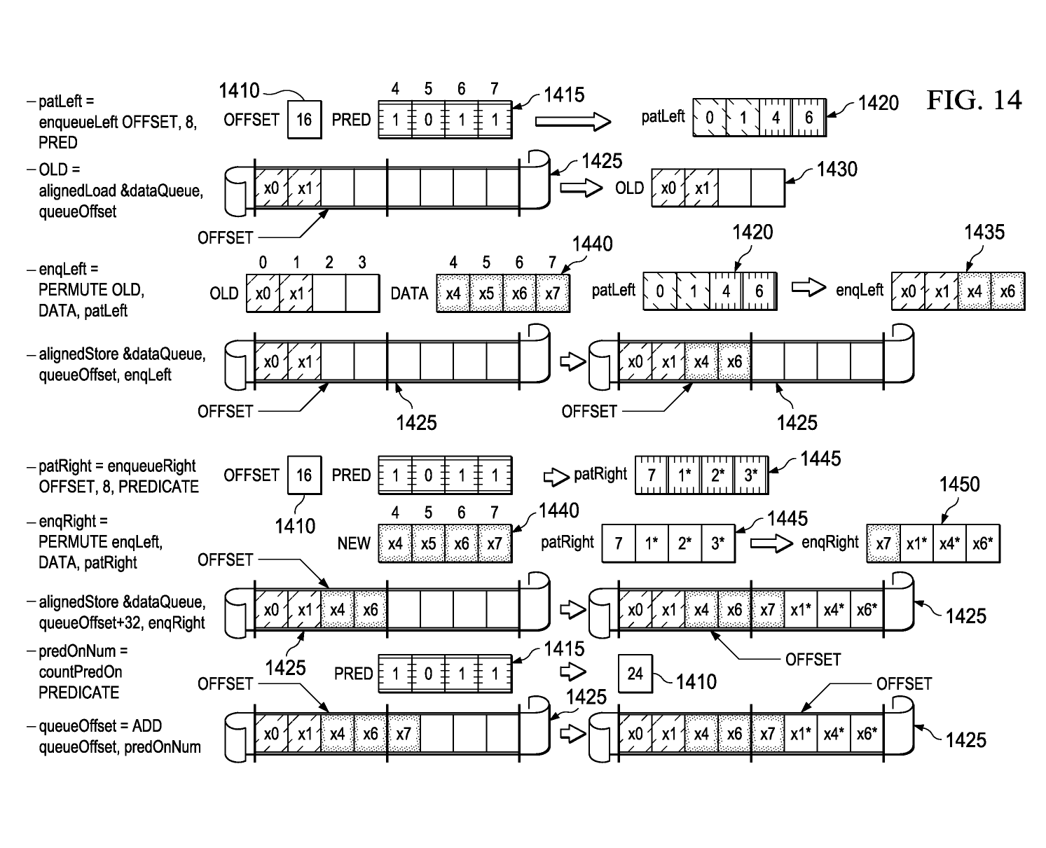

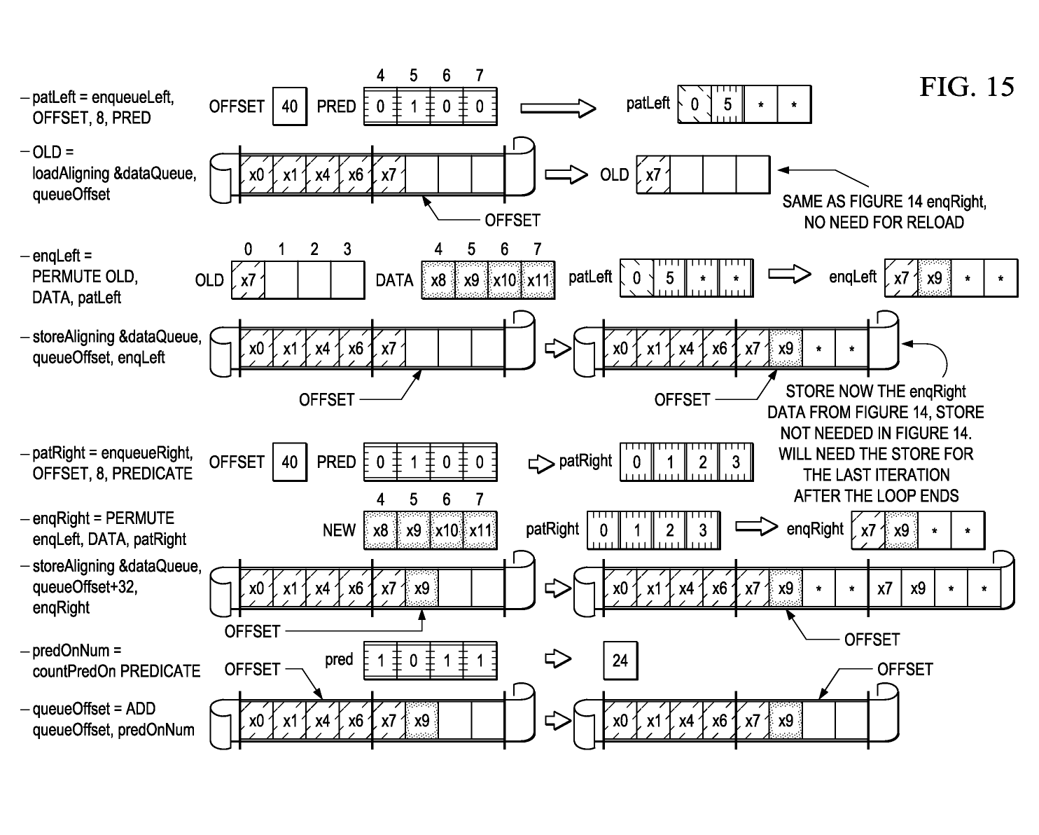

FIG. 14 is an example diagram illustrating a preferred use of the EnqueueLeft and EnqueueRight instructions in accordance with one illustrative embodiment. In this example, the memory access boundaries (the dark lines depicted with regard to memory 1425) are considered to be 32 bytes apart such that each memory region is 32 bytes in size. Of course, this is only an example, and other sizes of memory regions may be used without departing from the spirit and scope of the illustrative embodiments.

Initially, the left pattern is generated based on the offset and the predicate values in the predicate register. In this case, since the offset 1410 is 16 bytes, and each data element is assumed to have a size of 8 bytes, the offset initially points to the third vector slot of the pattern or mask vector register 1420. This offset 1410 is used to preserve old values that were previously written to the portion of memory between memory access boundaries to which the current data is going to be written.

The patLeft instruction then looks at the predicate vector register 1415 values and stores the vector slot numbers of the predicate vector register 1415 vector slots that have a “true” value. In this case, the pattern or mask vector register 1420 only has two slots to store values due to the offset 1410 being used to preserve the old values. The slots that are prior to the offset merely have their own slot numbers stored in these slots, e.g., 0 and 1 in the depicted example. This preserves the old data values already written to the portion of memory to which the current data is to be written. The slots of the predicate vector register 1415 that have “true” values have their slot numbers written to the pattern or mask vector register 1420 starting from left to right. Since there are only 2 slots left in the pattern/mask vector register 1420 due to the offset 1410, only slots 4 and 6 are written to the pattern/mask vector register 1420, i.e. the first two slot numbers of the predicate vector register 1415 that have “true” values.

Thereafter, the data is enqueued by first enqueuing the old data based on the offset 1410. That is, the data elements starting at the alignment boundary (dark line in the depiction of the memory 1425) of the memory 1425 up to the offset 1410 are written to the old data element vector register 1430. In this case, the old data values are x0 and x1.

Then, the new data values are selected from the input data element vector register 1440 using the pattern/mask vector register 1420 by performing a permute operation. The old data elements and the new data elements are written to the enqueue left vector register 1435. In the depicted example, the old values x0 and x1 are included in slots 0 and 1 of the enqueue left vector register 1435 and the new data values from the input data element vector register 1440 in slots 4 and 6 are written to slots 2 and 3 of the enqueue left vector register 1435 in accordance with the pattern/mask in the pattern/mask vector register 1420.

The enqueued data in the enqueue left vector register 1435 is written to the memory 1425 using an aligned store. This causes the x0 and x1 data values to be overwritten with the same data element values such that x0 and x1 are still present in the first and second portions of the memory 1425 portion and data elements x4 and x6 are written to the portion of memory 1425 starting at the offset 1410. This essentially writes the left portion of the predicate vector register 1415 data elements that have “true” predicate values to the memory 1425.

Having written the left portion of the predicate vector register 1415 to the memory 1425, the right portion of the predicate vector register 1415 now needs to be written to the memory 1425. The offset 1410 is again utilized along with the same predicate vector register 1415. This time, however, the right pattern instruction patRight is utilized to skip the predicate vector register 1415 slots already used in the left pattern/mask and select the predicate value(s) from the predicate vector register 1415 that were not used by the patLeft instruction. In the depicted example, this corresponds to slot 7 of the predicate vector register 1415. Thus, the right pattern/mask comprises slot number 7 in vector slot 0 of the right pattern/mask vector register 1445. The remaining values in the right pattern/mask vector register 1445 are “don't care” values.

Thereafter, the data is enqueued using the enqRight instruction which causes a permute operation on the input data element vector register 1440 based on the right pattern/mask in the right pattern/mask vector register 1445. This results in the data element from slot 7 of the input data element vector register 1440 being selected and inserted into slot 0 of the enqueue right vector register 1450 with the remaining slots being populated with “don't care” data elements. The data elements in the enqueue right vector register 1450 are then written to the memory 1425 using an aligned store instruction which causes the data elements to be written starting at the next memory access boundary.

The offset 1410 is then updated based on the predicate vector register 1415. That is, the offset is set to a value corresponding to a number of bytes of data elements associated with “true” predicate values. In this case, there are 3 predicate values that are “true” and thus, the offset 1410 is set to 24, i.e. 3×8 bytes per data element=24. As a result, the offset now points to data element x1* in the memory 1425 which is 24 bytes away from the previous offset that pointed to the data element just after x1. Subsequent writing of data elements to the memory 1425 will begin at the new offset 1410 such that the x1*, x4*, and x6* data elements will be overwritten.

FIG. 15 is an example diagram illustrating a preferred use of the EnqueueLeft and EnqueueRight instructions in a different case as in FIG. 14. Recall that in FIG. 14, the EnqueueRight instruction was generated to produce a mask needed to enqueue one more value (value x7) that was not enqueued while using the enqueueLeft mask. In FIG. 15, the other situation is depicted, namely, a case where all the values to be enqueued are processed while using the enqueueLeft mask.

As seen in FIG. 15, only one value needs to be enqueued (as the predicate has now the value 0, 1, 0, 0) resulting in the enqueueing of the x9 value in memory. As shown in FIG. 13, the enqueueRight instructions initialize the pattern with the (0, 1, 2, 3) values corresponding to copying the first data input fed to the permute instruction. Since there is no new values to enqueue here (as the only value to be enqueued has been processed with the EnqueueLeft instruction), all values for which the predicate is true are skipped. Thus, the final mask value resulting from the EnqueueRight instruction is (0,1,2,3) as shown by the patRight variable in FIG. 15. Thus, the memory will be written (i.e. a store operation will be performed) with a second replica of the values x7 and x9, but since these value are not at the end of the queue pointed by the offset, these values are actually don't care values.

What is important to note is that the enqRight variable contains the data that was last stored and that is at the head of the queue in memory. Indeed, one can see that both in FIG. 14 and in FIG. 15, the enqRight contains, respectively, the values (x7, *, *, *) and (x7, x9, *,*) which corresponds to the data that was last stored in memory and corresponds to the head of the queue. The head of the queue is the last data to the left of the offset pointer after it is updated. Since this example is dealing with aligned memory access, the data in enqRight corresponds to data that starts at a 0 mod 32 barrier and contains the 32 consecutive bytes of data starting from this 0 mod 32 barrier (bold vertical lines in FIGS. 14 and 15).

Because it has been shown that in the two possible cases (FIG. 14 where some new data is stored using the enqueueRight instruction and FIG. 15 where no new data is stored using the enqueueRight instruction), the values in enqRight correspond to the last stored data that is immediately to the left of the offset pointer, it is not necessary to perform the first “old=loadAligingn &dataQueue, queueOffset” instruction in the next loop iteration (enqueueing the next batch of values after evaluating a new predicate) as it will deliver, by definition, the same value as the one stored in the enqRight variable. Indeed, one can see that in this case, the enqRight value in FIG. 14 is the same as the old value in FIG. 15, as FIG. 15 corresponds to the processing of the next predicate after the predicate in FIG. 14 has been fully performed.

The mechanisms described above may be utilized by a compiler to optimize original source code into optimized executable code that utilizes the permute logic and counter logic functionality of the illustrative embodiments. The compiler may transform original code into optimized code that utilizes one or more of the permute logic based data enqueuing mechanisms described above. Thus, the compiler may optimize the execution of condition branch calculations by utilizing the pattern/mask generation, data enqueuing, data storing, and offset updating instructions described above.

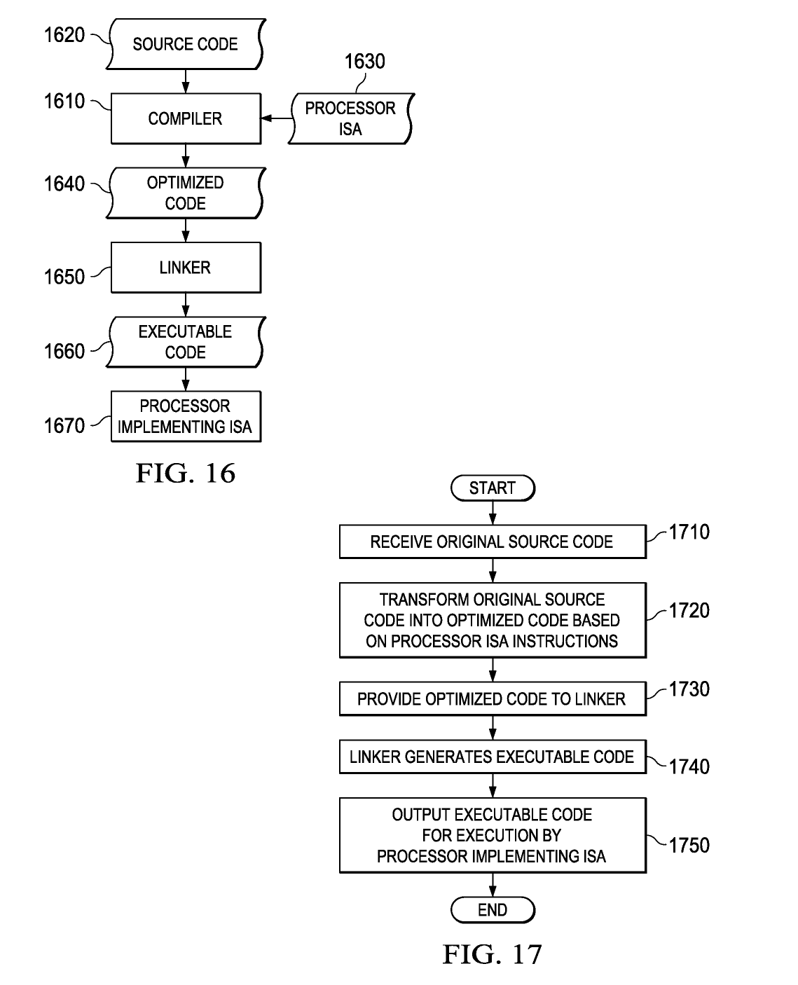

FIG. 16 is a block diagram illustrating a compiler optimization in accordance with one illustrative embodiment. As shown in FIG. 16, the compiler 1610 receives original source code 1620 which is analyzed in accordance with source code patterns associated with the processor architecture 1630 for which the compiler 1610 is configured. The compiler 1610 identities portions of the source code 1620 that meet the source code patterns corresponding to the processor architecture 1630.

The compiler then transforms the source code to utilize the instruction set architecture of the processor architecture 1630 which includes the pattern/mask generation, data enqueuing, data storing, and offset updating instructions described above. The result is optimized code 1640 that implements the processor architecture's ISA in accordance with the illustrative embodiments. This optimized code 1640 is then provided to linker 1650 that performs linker operations, as are generally known in the art, to thereby generate executable code 1660. The executable code 1660 may then be executed by the processor architecture.

FIG. 17 is a flowchart outlining an exemplary operation for compiling source code into executable code in accordance with one illustrative embodiment. As shown in FIG. 34, the operation starts by receiving original source code (step 1710). The compiler transforms the original source code into optimized code based on the processor architecture ISA, which includes the pattern/mask generation, data enqueuing, data storing, and offset updating instructions (step 1720). The optimized code is provided to a linker (step 1730). The linker links the optimized code modules, libraries, etc. and generates executable code (step 1740). The executable code is output for execution by a processor implementing the processor architecture's ISA (step 1750). The operation then terminates.

Thus, the illustrative embodiments provide mechanisms for implementing instructions for identifying iterations of a loop for which a conditional branch is taken so that only those iterations are used to perform calculations associated with the taken conditional branch. The SIMD instruction set architecture in accordance with the illustrative embodiments includes instructions for using pattern/mask generating logic and permute logic within the processor architecture to generate a pattern/mask and then use that pattern/mask to enqueue data elements corresponding to only those iterations of the loop for which the conditional branch is taken. These enqueued data elements are written to memory in an aligned or unaligned manner and may then be used to perform the calculations of the taken branch. The illustrative embodiments leverage the existing permute logic of the processor architecture to perform these operations.

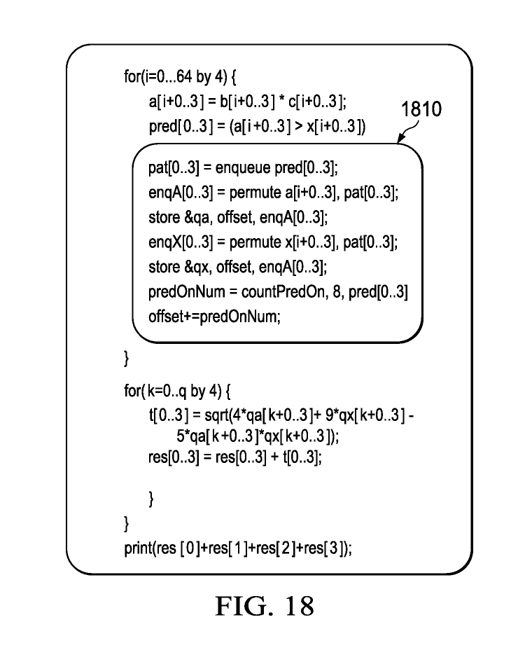

FIG. 18 is an example of code, corresponding to the code illustrated in FIG. 8, but using the new instructions for utilizing the permute logic and counter logic of the illustrative embodiments. The code shown in FIG. 18 may be generated by a compiler, such as in the manner previously described with regard to FIGS. 16 and 17 above. In this example, it is assumed that unaligned memory accesses are utilized by the processor architecture for simplicity. It will be readily apparent to those of ordinary skill in the art that the example shown in FIG. 18 may be modified to include the instructions previously described above with regard to FIGS. 14 and 15 should the architecture require aligned memory accesses.

In comparing FIG. 18 with FIG. 8, it can be seen that the portion 810 in FIG. 8 has been replaced with code portion 1810 having instructions for generating the pattern/mask based on the predicate vector register values calculated by the pred[0 . . . 3] instruction above code portion 1810, enqueuing data from an input data element vector register a[i+0 . . . 3] based on the generated pattern/mask using permute logic, and storing the enqueued data to memory. The same is done for the input data elements x[i+0 . . . 3], the counter value is updated, and then the offset is updated based on the counter value.

As stated previously, the code in the code segment 810 in FIG. 8 is scalar (i.e. not SIMD) and as a result the “if” statement needs to be executed V=4 times here. Second, the code is sequential, meaning each of the 4 iterations need to be computed one after the other due to data dependences between the loop iterations. Third, the code in 810 includes a conditional statement which results in a branch being evaluated 4 consecutive times during execution. Branches are expensive because modern processors perform branch prediction to avoid stalls in the pipeline. However, when the prediction is false, falsely fetched, possibly decoded, possibly executed instructions need to be flushed from the pipeline and the correct instructions need to be then fetched, decoded, and executed. Branches dependent on data (such as it is the case here where the branch depends on the actual value of the predicate register) are especially susceptible to branch misprediction as there are typically no known patterns for such data dependent branches.

Fourth, the computations performed in code 810 are scalar computations that use scalar registers. However the predicate register was computed using SIMD computation and its content is thus in a SIMD or vector register. Thus we must first transfer the content of the SIMD register over to the scalar registers. On many architectures, moving data from SIMD to scalar and vice versa can only be done via memory. This is typically slow and expensive.

Now contrast this with the code in code segment 1810 in FIG. 18. All the computations are SIMD computations. Thus, there is no sequential loop iterating over the 4 slots of the vector registers. Second, there are very few dependencies between the instructions in 1810 and hence, many of these instructions may execute either concurrently or in a pipelined fashion. Third, all branches have been eliminated and thus, there is no expensive branch mis-prediction resulting in flushing of falsely predicted instructions in the processor pipelines. Finally, as all computations are SIMD, there are no expensive transfers of values between the vector and scalar registers. To give a general idea of the costs, in FIG. 8, the code section 810 may results in up to 25 instructions for a traditional architecture whereas in FIG. 18, the code section 1810 requires 7 instructions, many of which can execute concurrently, assuming a similar architecture augmented by the above proposed embodiments.

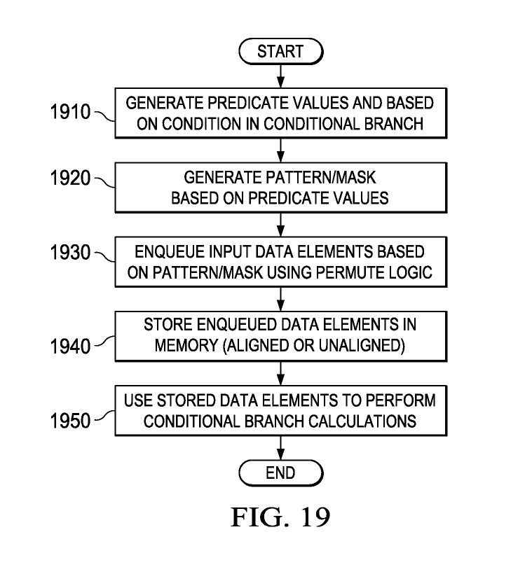

FIG. 19 is a flowchart outlining an example operation for generating enqueued data for a conditional branch within a loop in accordance with one illustrative embodiment. The operation outlined in FIG. 19 may be performed, for example, by the code portion 1810 in FIG. 18, for example.

As shown in FIG. 19, the operation starts with predicate values being generated and stored in a predicate vector register by evaluating a condition of a conditional branch for a plurality of iterations of a loop (step 1910). A pattern/mask is generated based on the predicate vector register values by identifying those predicate vector register values having a “true” value (step 1920). The pattern/mask may specify vector slot numbers for those vector slots in the predicate vector register having a “true” value.

Based on the pattern/mask, data elements from an input data element vector register are enqueued using permute logic (step 1930). This may involve selecting data elements in vector slots of the input data element vector register corresponding to the vector slot numbers specified in the pattern/mask. The selected data elements are stored to memory in either an aligned or unaligned manner (step 1940). The stored data elements are then used to perform calculations corresponding to the taken conditional branch (step 1950). The operation then terminates. It should be appreciated that this operation may be repeated for each conditional branch in the code.

As noted above, it should be appreciated that the illustrative embodiments may take the form of an entirely hardware embodiment, an entirely software embodiment or an embodiment containing both hardware and software elements. In one example embodiment, the mechanisms described above may be practiced by software (sometimes referred to Licensed Internal Code (LIC), firmware, micro-code, milli-code, pico-code and the like, any of which would be consistent with the illustrative embodiments of the present invention). Software program code which embodies the mechanisms of the illustrative embodiments is typically accessed by the processor, also known as a CPU (Central Processing Unit), of a computer system from long term storage media, such as a CD-ROM drive, tape drive or hard drive. The software program code may be embodied on any of a variety of known media for use with a data processing system, such as a diskette, hard drive, or CD-ROM. The code may be distributed on such media, or may be distributed to users from the computer memory or storage of one computer system over a network to other computer systems for use by users of such other systems.

Alternatively, the program code may be embodied in a memory, and accessed by a processor using a processor bus. Such program code includes an operating system which controls the function and interaction of the various computer components and one or more application programs. Program code is normally paged from dense storage media to high speed memory where it is available for processing by the processor. The techniques and methods for embodying software program code in memory, on physical media, and/or distributing software code via networks are well known and will not be further discussed herein. Program code, when created and stored on a tangible medium (including but not limited to electronic memory modules (RAM), flash memory, compact discs (CDs), DVDs, magnetic tape and the like is often referred to as a “computer program product”. The computer program product medium is typically readable by a processing circuit preferably in a computer system for execution by the processing circuit.

One or more aspects of the present invention are equally applicable to, for instance, virtual machine emulation, in which one or more pageable entities (e.g., guests) execute on one or more processors. As one example, pageable guests are defined by the Start Interpretive Execution (SIE) architecture described in “IBM® System/370 Extended Architecture”, IBM® Pub. No. SA22-7095 (1985).

In emulation mode, the specific instruction being emulated is decoded, and a subroutine is executed to implement the individual instruction, as in a subroutine or driver, or some other technique is used for providing a driver for the specific hardware, as is within the skill of those in the art after understanding the description hereof. Various software and hardware emulation techniques are described in numerous U.S. Pat Nos. including: 5,551,013, 5,574,873, 5,790,825, 6,009,261, 6,308,255, and 6,463,582. Many other teachings further illustrate a variety of ways to achieve emulation of an instruction format architected for a target machine. In one illustrative embodiment, the mechanisms of one or more of the other illustrative embodiments described above may be emulated using known or later developed software and/or hardware emulation techniques.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system comprising a processor, for generating enqueued data for performing computations of a conditional branch of code, comprising:
generating, by mask generation logic of the processor, a mask representing a subset of iterations of a loop of the code that results in a condition of the conditional branch being satisfied;
using the mask to select data elements from an input data element vector register corresponding to the subset of iterations of the loop of the code that result in the condition of the conditional branch being satisfied; and
using the selected data elements to perform computations of the conditional branch of code, wherein iterations of the loop of the code that do not result in the condition of the conditional branch being satisfied are not used as a basis for performing computations of the conditional branch of code.

2. The method of claim 1, wherein the mask is generated based on predicate values of a predicate instruction associated with the loop stored in one or more predicate vector registers.

3. The method of claim 2, wherein the predicate values indicate which iterations of the loop result in the condition of the conditional branch being satisfied, and wherein the mask indicates which vector slots of the one or more predicate vector registers correspond to iterations of the loop for which the condition of the conditional branch is satisfied.

4. The method of claim 3, wherein the mask is input as a control vector input to a permute unit, and wherein the mask controls selection of the data elements by the permute unit from the input data element vector register which provides the data elements to the permute unit as input.

5. The method of claim 4, wherein the data elements are selected by the permute unit by selecting data elements in the input data element vector register that are stored in vector slots of the input data element vector register corresponding to the vector slots specified in the mask.

6. The method of claim 5, wherein the mask comprises a set of vector slot identifiers written to a mask register in a consecutive manner with any additional slots of the mask register that do not store a vector slot identifier storing a don't care value.

7. The method of claim 1, wherein the generating and using operations are performed by a permute logic unit of the processor.

8. The method of claim 1, further comprising:
for each value in the predicate vector register indicating that the condition of the conditional branch is satisfied, incrementing a counter by a data size for a data element.

9. The method of claim 8, wherein the counter is used as an offset value for locating the selected data elements in memory.

10. The method of claim 1, further comprising storing the selected data elements in a memory in an unaligned manner.

11. An apparatus, comprising:
mask generation logic that generates a mask representing a subset of iterations of a loop of code that results in a condition of a conditional branch of the loop being satisfied;
permute unit that uses the mask to select data elements from an input data element vector register corresponding to the subset of iterations of the loop of the code that result in the condition of the conditional branch being satisfied; and
computational logic that uses the selected data elements to perform computations of the conditional branch of code, wherein iterations of the loop of the code that do not result in the condition of the conditional branch being satisfied are not used as a basis for performing computations of the conditional branch of code.

12. The apparatus of claim 11, wherein the mask is generated based on predicate values of a predicate instruction associated with the loop stored in one or more predicate vector registers.

13. The apparatus of claim 12, wherein the predicate values indicate which iterations of the loop result in the condition of the conditional branch being satisfied, and wherein the mask indicates which vector slots of the one or more predicate vector registers correspond to iterations of the loop for which the condition of the conditional branch is satisfied.

14. The apparatus of claim 13, wherein the mask is input as a control vector input to the permute unit, and wherein the mask controls selection of the data elements by the permute unit from the input data element vector register which provides the data elements to the permute unit as input.

15. The apparatus of claim 14, wherein the data elements are selected by the permute unit by selecting data elements in the input data element vector register that are stored in vector slots of the input data element vector register corresponding to the vector slots specified in the mask.

16. The apparatus of claim 15, wherein the mask comprises a set of vector slot identifiers written to a mask register in a consecutive manner with any additional slots of the mask register that do not store a vector slot identifier storing a don't care value.

17. The apparatus of claim 11, further comprising:
a counter that, for each value in the predicate vector register indicating that the condition of the conditional branch is satisfied, is incremented by a data size for a data element.

18. The apparatus of claim 17, wherein the counter is used to provide an offset value for locating the selected data elements in memory.

19. The apparatus of claim 11, wherein the selected data elements are stored in the memory in an unaligned manner.

20. A computer program product comprising a computer readable storage medium having a computer readable program recorded thereon, wherein the computer readable program, when executed on a computing device, causes the computing device to:
generate, by mask generation logic of the computing device, a mask representing a subset of iterations of a loop of the code that results in a condition of the conditional branch being satisfied;
use the mask to select data elements from an input data element vector register corresponding to the subset of iterations of the loop of the code that result in the condition of the conditional branch being satisfied; and
use the selected data elements to perform computations of the conditional branch of code, wherein iterations of the loop of the code that do not result in the condition of the conditional branch being satisfied are not used as a basis for performing computations of the conditional branch of code.
